(19) United States
(12) Patent Application Publication
(10) Pub. No.: US 2012/0030712 A1
(43) Pub. Date: Feb. 2, 2012

(54) NETWORK-INTEGRATED REMOTE CONTROL WITH VOICE ACTIVATION

(75) Inventor: Hisao Chang, Cedar Park, TX (US)

(73) Assignee: AT&T INTELLECTUAL PROPERTY I, L.P., Reno, NV (US)

(21) Appl. No.: 12/848,464

(22) Filed: Aug. 2, 2010

(51) Int. Cl. H04N 5/445; G10L 15/26; G10L 21/00

(52) U.S. Cl. 725/52; 704/275; 704/235; 725/53; 725/39

(57) ABSTRACT

A method and system for network-integrated remote control includes voice activation of a user interface context on a remote control device. A user may utter a voice command, which the remote control device may use to obtain a user interface context from a network server. The user interface context may be used by the remote control device to display a user interface. The voice command may be associated with desired multimedia content, which may be selectable using control elements in the user interface. The remote control device can then be used to select and control desired multimedia programs.

### FIELD OF THE DISCLOSURE

The present disclosure relates to remote control and, more particularly, to network-integrated remote control.

### BACKGROUND

Remote control devices are among commonly used consumer appliances and may be used with many different kinds of equipment. Televisions are among the equipment that are typically controlled using a remote control device. The complexity of remote control devices has increased over the years.

### BRIEF DESCRIPTION OF THE DRAWINGS

FIG. 1 is a block diagram of selected elements of an embodiment of a multimedia content distribution network;

FIG. 2 is a block diagram depicting further detail of selected elements of the embodiment of the MCDN depicted in FIG. 1;

FIG. 3 is a block diagram of selected elements of an embodiment of a multimedia handling device;

FIG. 4 is a block diagram of selected elements of an embodiment of a network-integrated remote control system;

FIG. 5 is a flow diagram of an embodiment of a method for network-integrated remote control;

FIG. 6 is a flow diagram of an embodiment of a method for network-integrated remote control; and

FIG. 7 is a block diagram of selected elements of an embodiment of a remote control device.

### DETAILED DESCRIPTION

In one aspect, a disclosed method for providing remote control via a multimedia content distribution network (MCDN) includes receiving, at an MCDN server, a voice command signal indicative of a voice command from an MCDN client. The voice command may be indicative of desired multimedia content at the MCDN client. The method may include sending, to the MCDN client, a user interface message indicative of a user interface usable by the MCDN client to display control elements pertaining to the desired multimedia content, and receiving, at the MCDN server, an indication of a selection of a displayed control element. The method may further include causing multimedia content associated with the selection to be processed, including at least one of: sending the multimedia content to the MCDN client, recording the multimedia content, and playing back the multimedia content. The user interface may be usable by the MCDN client to display the control elements on a remote control device display. The indication of the selection may be received via the remote control device. The voice command signal may be received at the MCDN server as an audio signal and/or in a textual language format. The voice command may be indicative of at least one category of multimedia content, such as a geographic location, a topic of discussion, a dialog, an object, an event, a purchasable good, symbols, animals, colors, brand names, an actor, a character, a program genre, a name, a codeword, a topic, or any combination thereof.

In certain embodiments, the method may further include determining a search term describing the desired multimedia content, in response to receiving the voice command signal. The method may also include sending the search term to an electronic programming guide (EPG) search engine, and receiving, from the EPG search engine, a list of multimedia programs corresponding to the search term. The method may further include including at least a portion of the list of multimedia programs in the user interface. The list of multimedia programs may include video-on-demand (VOD) programs categorized according to at least one of genre, studio, duration, era, release year, sales revenue, language, media-type or format, performer, director, producer, investor, author, shooting location, trade association rating, content warnings, crew members, award information, or any combination thereof.

In a further aspect, a disclosed multimedia handling device (MHD) for performing network-integrated remote control over an MCDN includes a processor coupled to memory media and a local wireless transceiver. The memory media may include executable instructions to receive a voice command signal from a remote control device at the local wireless transceiver, send the voice command signal to an MCDN server, and receive, from the MCDN server, a user interface context usable by the remote control device to display a user interface. The memory media may further include executable instructions to send the user interface context to the remote control device, and receive a selection command from the remote control device. The selection command may originate from a user interaction with the user interface. Responsive to receiving a selection command, the executable processor instructions may further display multimedia content associated with the selection command. The user interface may include display elements, while the selection command may be associated with a display element. The voice command signal may be received as an audio signal and/or in a textual language format.

In yet another aspect, a disclosed computer-readable memory media includes executable instructions for network-integrated remote control of an MCDN client. Instructions to receive an audio command from a user of the MCDN client, and send, using a local remote control (RC) interface, an audio signal corresponding to the audio command to an MCDN server via the MCDN client may be included. The memory media may further include instructions to receive, from the MCDN server via the local RC interface, a user interface context depending on the audio command, and display a user interface on a display screen of a remote control device. The user interface may be based on the user interface context and may include control elements for controlling multimedia programs at the MCDN client. The local interface may be configured to send the audio signal using at least one of: voice over Internet protocol (VoIP) and voice over wireless local area network (VoWLAN).

In given embodiments, the memory media may further include instructions to receive first user input selecting a first control element associated with a first multimedia program, and send, via the local RC interface, a channel selection command for the first multimedia program. The user interface may include a list of multimedia programs associated with the audio command, while the control elements may be usable to select individual multimedia programs in the list of multimedia programs. The memory media may also include instructions executable to display, based on the user interface, instructions for navigating the user interface. The navigating instructions may indicate audio commands accepted by the remote control device. The navigating instructions may indicate control elements displayed by the remote control device. The user interface may be configured to enable the user to access an EPG at the MCDN client. The memory media may still further include instructions to receive further user input selecting a further control element for accessing the EPG.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

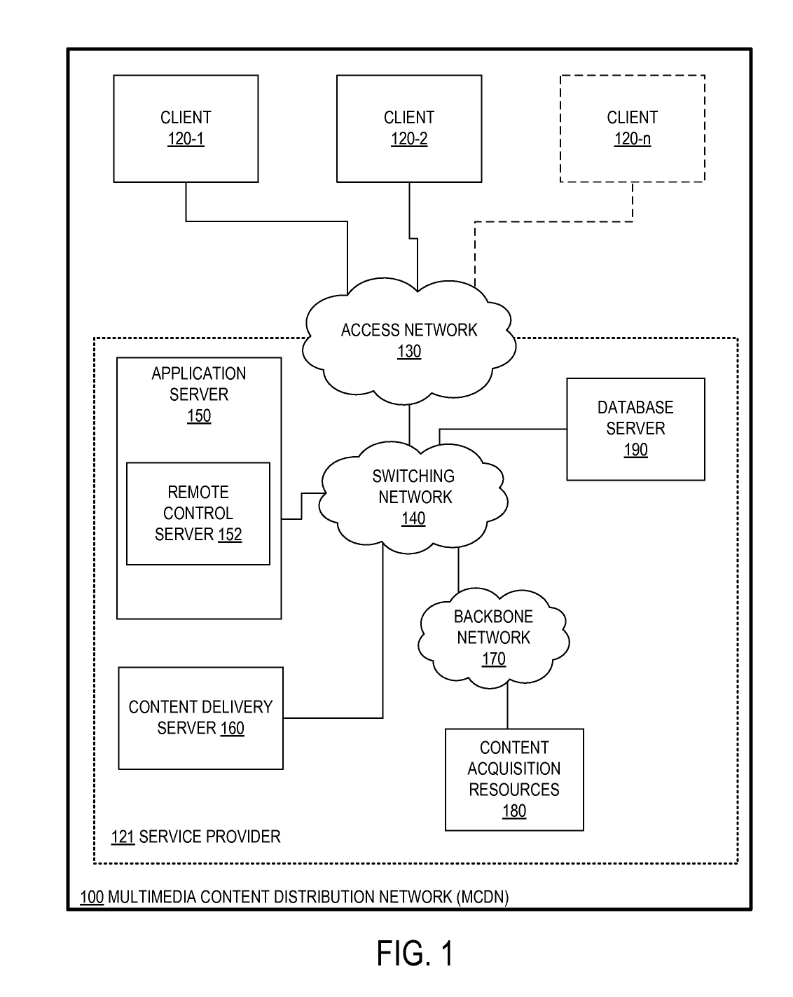

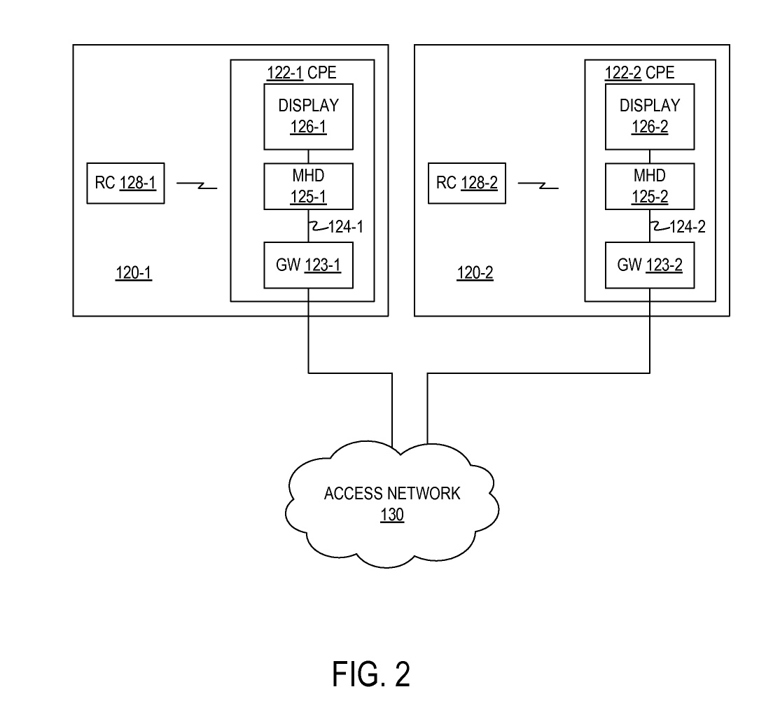

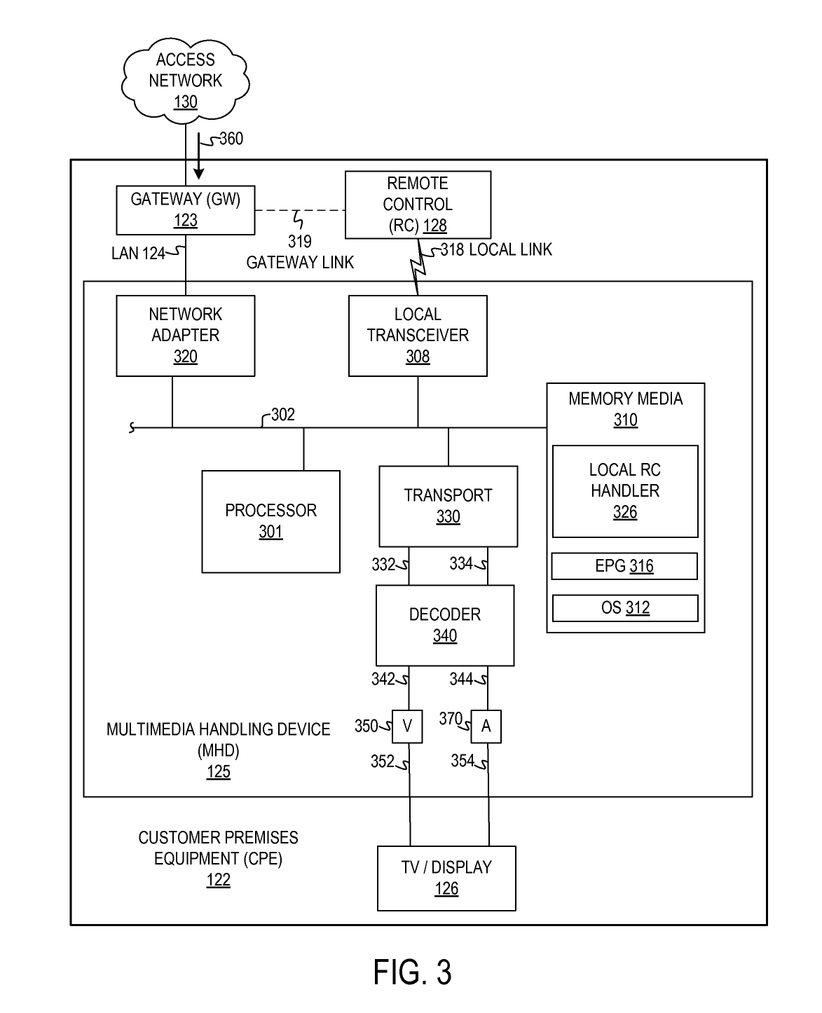

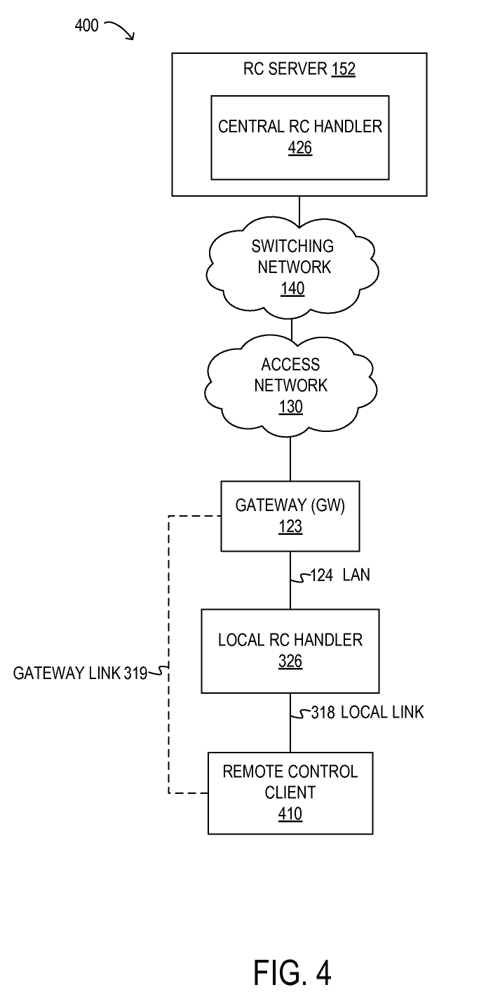

Turning now to the drawings, FIG. 1 is a block diagram illustrating selected elements of an embodiment of MCDN 100. Although multimedia content is not limited to TV, VOD, or pay-per-view (PPV) programs, the depicted embodiments of MCDN 100 and its capabilities are primarily described herein with reference to these types of multimedia content, which are interchangeably referred to herein as “multimedia content”, “multimedia content programs”, “multimedia programs” or, simply, “programs.” As described further in conjunction with subsequent figures, embodiments of client(s) 120 in MCDN 100 include an MHD 125 (depicted in FIG. 2 and FIG. 3) hosting or otherwise employing a local RC handler 326 (depicted in FIG. 3). In addition, embodiments of remote control server 152 of MCDN 100 host or otherwise employ a central RC handler 426 (depicted in FIG. 4). Local RC handler 326 and Central RC handler 426 may cooperate to provide remote control functionality including voice command remote control functionality. In some embodiments, as described further below, central RC handler 426 may be configured to process relatively complex commands and local RC hander 326 may be configured to process relatively less complex commands with lower latency.

The elements of MCDN 100 illustrated in FIG. 1 depict network embodiments with functionality for delivering multimedia content to a set of one or more subscribers. It is noted that different embodiments of MCDN 100 may include additional elements or systems (not shown in FIG. 1 for clarity) as desired for additional functionality, such as data processing systems for billing, content management, customer support, operational support, or other business applications.

As depicted in FIG. 1, MCDN 100 includes one or more clients 120 and a service provider 121. Each client 120 may represent a different subscriber of MCDN 100. In FIG. 1, a plurality of n clients 120 is depicted as client 120-1, client 120-2 to client 120-n, where n may be any number. Service provider 121 as depicted in FIG. 1 encompasses resources to acquire, process, and deliver programs to clients 120 via access network 130. Such elements in FIG. 1 of service provider 121 include content acquisition resources 180 connected to switching network 140 via backbone network 170, as well as application server 150, database server 190, and content delivery server 160, also shown connected to switching network 140.

Access network 130 demarcates clients 120 and service provider 121, and provides at least one connection path between clients 120 and service provider 121. In some embodiments, access network 130 is an Internet protocol (IP) compliant network. In some embodiments, access network 130 is, at least in part, a coaxial cable network. It is noted that in some embodiments of MCDN 100, access network 130 is owned and/or operated by service provider 121. In other embodiments, a third party may own and/or operate at least a portion of access network 130.

In IP-compliant embodiments of access network 130, access network 130 may include a physical layer of unshielded twisted pair cables, fiber optic cables, or a combination thereof. MCDN 100 may include digital connections between clients 120 and a node (see also FIG. 4) in access network 130 while fiber, cable or another broadband medium connects service provider resources to the node. In other embodiments, the broadband cable may extend all the way to clients 120. In certain embodiments, fiber optic cables may be provided from the node in access network 130 to each individual client 120. The connections between access network 130 and clients 120 may include digital subscriber line (DSL) connections. In particular embodiments, the connections may be DSL-compliant twisted pair or another type of galvanic loop (see also FIG. 4).

As depicted in FIG. 1, switching network 140 provides connectivity for service provider 121, and may be housed in a central office or other facility of service provider 121. Switching network 140 may provide firewall and routing functions to demarcate access network 130 from the resources of service provider 121. In embodiments that employ DSL-compliant connections, switching network 140 and/or access network 130 may include elements of a DSL Access Multiplexer (DSLAM) (not depicted) that multiplexes many subscriber DSLs to backbone network 170.

In FIG. 1, backbone network 170 represents a private network including, as an example, a fiber based network to accommodate high data transfer rates. Content acquisition resources 180 as depicted in FIG. 1 encompass the acquisition of various types of content including broadcast content, other “live” content including national content feeds, and VOD content.

Thus, the content provided by service provider 121 encompasses multimedia content that is scheduled in advance for viewing by clients 120 via access network 130. Such multimedia content, also referred to herein as “scheduled programming,” may be selected using an EPG, such as EPG 316 described below with respect to FIG. 3. Accordingly, a user of MCDN 100 may be able to browse scheduled programming in advance of the broadcast date and time. Some scheduled programs may be “regularly” scheduled programs, which recur at regular intervals or at the same periodic date and time (i.e., daily, weekly, monthly, etc.). Programs which are broadcast at short notice or interrupt scheduled programs are referred to herein as “unscheduled programming.”

Acquired content is provided to content delivery server 160 via backbone network 170 and switching network 140. Content may be delivered from content delivery server 160 to clients 120 via switching network 140 and access network 130. Content may be compressed, encrypted, modulated, demodulated, and otherwise encoded or processed at content acquisition resources 180, content delivery server 160, or both. Although FIG. 1 depicts a single element encompassing acquisition of all content, different types of content may be acquired via different types of acquisition resources. Similarly, although FIG. 1 depicts a single content delivery server 160, different types of content may be delivered by different servers. Moreover, embodiments of MCDN 100 may include content acquisition resources in regional offices that are connected to switching network 140.

Although service provider 121 is depicted in FIG. 1 as having switching network 140 to which content acquisition resources 180, content delivery server 160, and application server 150 are connected, other embodiments may employ different switching networks for each of these functional components and may include additional functional components (not depicted in FIG. 1) including, for example, operational subsystem support (OSS) resources.

FIG. 1 also illustrates application server 150 connected to switching network 140. As suggested by its name, application server 150 may host or otherwise implement one or more applications for MCDN 100. Application server 150 may be any data processing system with associated software that provides applications for clients or users. Application server 150 may provide services including multimedia content services, e.g., EPGs, digital video recording (DVR) services, VOD programs, PPV programs, IPTV portals, digital rights management (DRM) servers, navigation/middleware servers, conditional access systems (CAS), and remote diagnostics, as examples.

Applications provided by application server 150 may be downloaded and hosted on other network resources including, for example, content delivery server 160, switching network 140, and/or clients 120. Application server 150 is configured with a processor and storage media (not shown in FIG. 1) and is enabled to execute processor instructions, such as those included within a software application. As depicted in FIG. 1, application server 150 may be configured to include remote control server 152, which, as will be described in detail below, may be configured to support voice activated and network-integrated remote control at client 120. Application server 150 may further include additional applications (not shown in FIG. 1) that may provide various functionality to clients 120.

Further depicted in FIG. 1 is database server 190, which provides hardware and software resources for data warehousing. Database server 190 may communicate with other elements of the resources of service provider 121, such as application server 150 or content delivery server 160, in order to store and provide access to large volumes of data, information, or multimedia content. In some embodiments, database server 190 includes a data warehousing application, accessible via switching network 140, that can be used to record and access structured data, such as program or channel metadata for clients 120. Database server 190 may also store device information, such as identifiers for client 120, model identifiers for remote control devices, identifiers for peripheral devices, etc.

Turning now to FIG. 2, clients 120 are shown in additional detail with respect to access network 130. As suggested above with respect to FIG. 1, embodiments of MHD 125 within a client 120 include a local RC handler 326 (see FIG. 3) for implementing at least some aspects of voice-based remote control functionality. Clients 120 may include a network appliances collectively referred to herein as client premises equipment (CPE) 122. In the depicted embodiment, CPE 122 includes the following devices: gateway (GW) 123, MHD 125, and display device 126. Any combination of GW 123, MHD 125, and display device 126 may be integrated into a single physical device. Thus, for example, CPE 122 might include a single physical device that integrates GW 123, MHD 125, and display device 126. As another example, MHD 125 may be integrated into display device 126, while GW 123 is housed within a physically separate device.

In FIG. 2, GW 123 provides connectivity for client 120 to access network 130. GW 123 provides an interface and conversion function between access network 130 and client-side local area network (LAN) 124. GW 123 may include elements of a conventional DSL or cable modem. GW 123, in some embodiments, may further include routing functionality for routing multimedia content, conventional data content, or a combination of both in compliance with IP or another network layer protocol. In some embodiments, LAN 124 may encompass or represent an IEEE 802.3 (Ethernet) LAN, an IEEE 802.11-type (WiFi) LAN, or a combination thereof. GW 123 may still further include WiFi or another type of wireless access point to extend LAN 124 to wireless-capable devices in proximity to GW 123. GW 123 may also provide a firewall (not depicted) between clients 120 and access network 130.

Clients 120 as depicted in FIG. 2 further include a display device or, more simply, a display 126. Display 126 may be implemented as a TV, a liquid crystal display screen, a computer monitor, or the like. Display 126 may comply with a display standard such as National Television System Committee (NTSC), Phase Alternating Line (PAL), or another suitable standard. Display 126 may include one or more integrated speakers to play audio content.

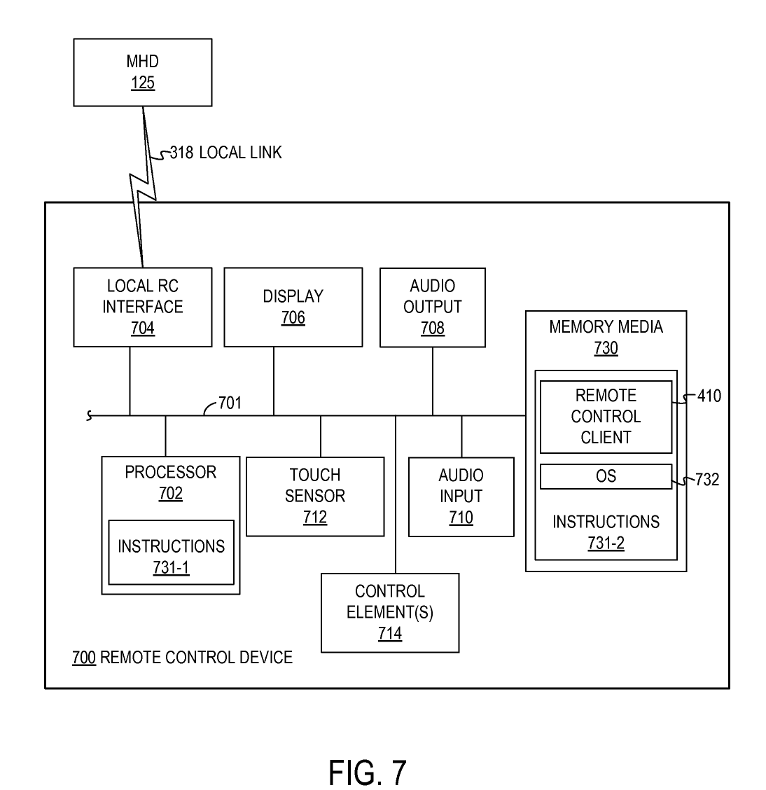

Clients 120 are further shown with their respective remote control 128, which is configured to control the operation of MHD 125 by means of a user interface (not shown in FIG. 2) displayed on display 126. Remote control 128 of client 120 may be operable to communicate requests or commands wirelessly to MHD 125 using infrared (IR) or radio frequency (RF) signals. Furthermore, remote control 128 may be configured to accept voice commands and forward voice commands, or data representing the voice commands, to remote control server 152. Remote control 128 may also be configured to accept a “user interface context” (i.e., an environment for interacting with the user and allowing the user to select displayed commands and features) and to display a corresponding user interface, which may be dynamic and/or context-specific in nature, as will be described in detail herein (see also FIG. 7). MHDs 125 may also receive requests or commands via buttons (not depicted) located on MHDs 125.

In some embodiments, remote control 128 may represent a device that is configured to control multiple pieces of equipment. When the equipment controlled by remote control 128 changes, remote control 128 may be reprogrammed, for example, to add a new device. Remote control 128 may, in certain instances, be programmed using a local transceiver (see FIG. 3) coupled to CPE 122.

MHD 125 may be enabled and configured to process incoming multimedia signals to produce audio and visual signals suitable for delivery to display 126 and any optional external speakers (not depicted in FIG. 2). Incoming multimedia signals received by MHD 125 may be compressed and/or encrypted, digital or analog, packetized for delivery over packet-switched embodiments of access network 130 or modulated for delivery over cable-based access networks. In some embodiments, MHD 125 may be implemented as a stand-alone set top box suitable for use in a co-axial or IP-based multimedia content delivery network.

Referring now to FIG. 3, a block diagram illustrating selected elements of an embodiment of MHD 125 is presented. In FIG. 3, MHD 125 is shown as a functional component of CPE 122 along with GW 123 and display 126, independent of any physical implementation, as discussed above with respect to FIG. 2. In particular, it is noted that CPE 122 may be any combination of GW 123, MHD 125 and display 126.

In the embodiment depicted in FIG. 3, MHD 125 includes processor 301 coupled via shared bus 302 to storage media, collectively identified as memory media 310. MHD 125, as depicted in FIG. 3, further includes network adapter 320 that interfaces MHD 125 to LAN 124 and through which MHD 125 receives multimedia content 360. GW 123 is shown providing a bridge between access network 130 and LAN 124, and receiving multimedia content 360 from access network 130.

In embodiments suitable for use in IP-based content delivery networks, MHD 125, as depicted in FIG. 3, may include transport unit 330 that assembles the payloads from a sequence or set of network packets into a stream of multimedia content. In coaxial-based access networks, content may be delivered as a stream that is not packet-based and it may not be necessary in these embodiments to include transport unit 330. In a co-axial implementation, however, clients 120 may require tuning resources (not explicitly depicted in FIG. 3) to “filter” desired content from other content that is delivered over the coaxial medium simultaneously and these tuners may be provided in MHDs 125. The stream of multimedia content received by transport unit 330 may include audio information and video information and transport unit 330 may parse or segregate the two to generate video stream 332 and audio stream 334 as shown.

Video and audio streams 332 and 334, as output from transport unit 330, may include audio or video information that is compressed, encrypted, or both. A decoder unit 340 is shown as receiving video and audio streams 332 and 334 and generating native format video and audio streams 342 and 344. Decoder 340 may employ any of various widely distributed video decoding algorithms including any of the Motion Pictures Expert Group (MPEG) standards, or Windows Media Video (WMV) standards including WMV 9, which has been standardized as Video Codec-1 (VC-1) by the Society of Motion Picture and Television Engineers. Similarly decoder 340 may employ any of various audio decoding algorithms including Dolby® Digital, Digital Theatre System (DTS) Coherent Acoustics, and Windows Media Audio (WMA).

The native format video and audio streams 342 and 344 as shown in FIG. 3 may be processed by encoders/digital-to-analog converters (encoders/DACs) 350 and 370 respectively to produce analog video and audio signals 352 and 354 in a format compliant with display 126, which itself may not be a part of MHD 125. Display 126 may comply with any television display standard or with any of a variety of standards for computer monitors. Standards for computer monitors include analog standards such as video graphics array (VGA), extended graphics array (XGA), etc., or digital standards such as digital visual interface (DVI) and high definition multimedia interface (HDMI), among others. A television display may comply with standards such as NTSC, PAL, or another suitable standard.

Local transceiver 308 represents an interface of MHD 125 for communicating with external devices, such as remote control 128 or another remote control device via a local link 318. Local transceiver 308 may provide a mechanical interface for coupling to an external device, such as a plug, socket, or other proximal adapter (not shown in FIG. 3). In various embodiments, local link 318 supports packet-based network protocols, such as an IP-compliant network protocol. When local link 318 is used to transmit voice commands, VoIP standard protocol may be implemented. In some cases, local transceiver 308 may be a wireless transceiver, configured to send and receive IR or RF or other signals via local link 318. Accordingly, local link 318 may represent an IR link, an RF link, or a wireless network link, such as a wireless network according to an IEEE 802.11 standard. In certain embodiments, local link 318 may support VoWLAN (or VoWiFi) for transmitting audio signals, such as speech signals, and/or network data representing audio signals. It is noted that local transceiver 308 may be accessed by a local remote control (RC) handler 326 for providing remote control functionality.

FIG. 3 also depicts a gateway link 319 coupling remote control 128 directly to GW 123. Like local link 318, gateway link 319 may be an IR link, an RF link, or an IEEE 802.11 or other type of wireless network link. In some embodiments, commands from remote control 128, including voice commands, may be processed or handled by either of two (or more) handlers including the local RC handler 326 as well as a networked or central RC handler 426 (see FIG. 4 described below) residing in remote control server 152. In these dual handler implementations, local RC handler 326 may be configured as a relatively light-weight processing module suitable for quickly processing commands of lesser complexity whereas central RC handler 426 may be configured as a more computationally complex handler suitable for processing commands of greater complexity. For example, a relatively simple user command such as a command for “sports content” may be performed rapidly by local RC handler 326. Because, however, local RC handler 326 resides in customer premises equipment, cost considerations may impose limitations on the computational complexity that local RC handler 326 may support.

Central RC handler 426 may be implemented and employed to process voice commands that require processing capabilities exceeding those of local RC handler 326. Central RC handler 426 may be implemented with greater processing resources to resolve relatively complex voice commands such as “top 10 action movies,” which requires substantially greater intelligence to decipher what the user meant. In this case, central RC handler 426 may respond to receiving a signal or message indicating a voice command by activating any of various natural language understanding (NLU) software agents either serially or in parallel to determine the meaning of the command. After resolving a command, central RC handler 426 may then send instructions back to remote control 128 via gateway link 319 or directly to MHD 125. Moreover, some voice commands, whether of high or low complexity, may result in an action that does not require the generation of a user interface and, in the case of these commands, the handler that processes the command, whether it be local RC handler 326 or central RC handler 426, may return one or more instructions that cause MHD 125 to perform an action without generating a user interface. Thus, for example, a voice command “change to any channel showing a Salma Hayek movie from the 1990's,” although of substantial complexity requiring processing by central RC handler 426, may produce a channel change action rather than the generation of a remote control user interface.

When remote control 128 sends a command to central RC handler 426, remote control 128 may send the command over gateway link 319 directly to GW 123 and central RC handler 426 rather than via MHD 125. In some cases, remote control 128 may send a command to central RC handler 426 via gateway link 319 as well as to local RC handler 326 via local link 318. In these cases, remote control 128 and/or MHD 125 may be configured to execute instructions from the first handler to respond and ignore the analogous instructions from any handler that is not first.

Memory media 310 may encompass persistent and volatile media, fixed and removable media, and magnetic and semiconductor media. Memory media 310 is operable to store instructions, data, or both. Memory media 310 as shown may include sets or sequences of instructions, namely, an operating system 312, EPG 316, and local RC handler 326. Operating system 312 may be a UNIX or UNIX-like operating system, a Windows® family operating system, or another suitable operating system. In some embodiments, memory media 310 is configured to store and execute instructions provided as services to client 120 by application server 150, as mentioned previously. For example, local RC handler 326 may be configured to receive remote control commands (including voice commands) from remote control 128, communicate with remote control server 152 and remote control 128, and/or execute remote control functions for controlling multimedia content output to display 126, as will be described in further detail below.

EPG 316 represents a guide to the multimedia content provided to client 120 via MCDN 100, and may be shown to the user as an element of a user interface. The user interface may include a plurality of menu items arranged according to one or more menu layouts, which enable a user to operate MHD 125. The user may operate the user interface, including EPG 316, using remote control 128 (see FIG. 2).

Turning now to FIG. 4, a block diagram of selected elements of an embodiment of network-integrated remote control system 400 is depicted. As depicted in FIG. 4, system 400 includes elements enabling communication between a remote control client 410 and remote control server 152 to provide network-integrated remote control functionality within MCDN 100 (FIG. 1). It is noted that in different embodiments, elements depicted in system 400 may be rearranged or reconfigured with desired or additional functionality.

In FIG. 4, remote control client 410 is depicted coupled to local RC handler 326 via local link 318 and further coupled to GW 123 via gateway link 319 as discussed above. Remote control client 410 represents an executable module on remote control 128 (see also FIG. 7). Remote control client 410 may thus include executable instructions for operation of remote control 128, including receiving user input and providing user output, as will be described in detail below with respect to FIG. 7. In system 400, remote control client 410 is configured to access local RC handler 326 via local link 318 (see also FIG. 3) and central RC handler 426 via gateway link 319. Local RC handler 326 may then communicate with remote control server 152 via various elements across an MCDN. Specifically, local RC handler 326 may communicate using GW 123 via LAN 124 through access network 130. Access network 130 may enable further communication through switching network 140 to application server 150 (not shown in FIG. 4), which may host remote control server 152 (see also FIG. 1). In this manner, remote control server 152 may centrally and individually communicate across MCDN 100 with a number of instances of local RC handler 326 and remote control client 410, representing a number of individual MCDN clients 120. It is noted that the methods described herein refer to a single instance of local RC handler 326 and remote control client 410 in generic form for descriptive clarity, but may also represent collective instances of these elements in MCDN 100 with any number of clients 120 (see FIG. 1).

In operation of system 400, local RC handler 326 may be configured to receive a voice command from remote control client 410, which may have been received by remote control 128 by an MCDN user. The voice command may be transmitted over local link 318 as an audio signal or as a textual representation of speech uttered by the MCDN user or both. The voice command may be indicative of multimedia content desired by the MCDN user, including multimedia programs, program guides, and/or instructions for operating remote control 128, among other types of multimedia content. An indication of the voice command may then be forwarded by local RC handler 326 to remote control server 152. In response, local RC handler 326 may receive multimedia content from remote control server 152.

In particular embodiments, the received multimedia content may include a user interface context, usable by remote control client 410 to display a user interface on remote control 128. Remote control client 410 may then receive the user interface context and display the user interface, including displayed control elements associated with the desired multimedia content. The control elements may be viewed and selected by the MCDN user. In certain embodiments, the user interface context may further include audio output and/or audio-visual elements that may be output by local RC handler 326 executing on MHD 125 (not shown in FIG. 4, see FIG. 3) and/or by remote control client 410 executing on remote control 128 (not shown in FIG. 4, see FIG. 7). It is noted that, in certain embodiments, a user interface context may be configured to operate in conjunction with EPG 316 (see FIG. 3). In this manner, remote control client 410 may provide network-integrated remote control functionality, including voice activation, in conjunction with MCDN 100 (see FIG. 1).

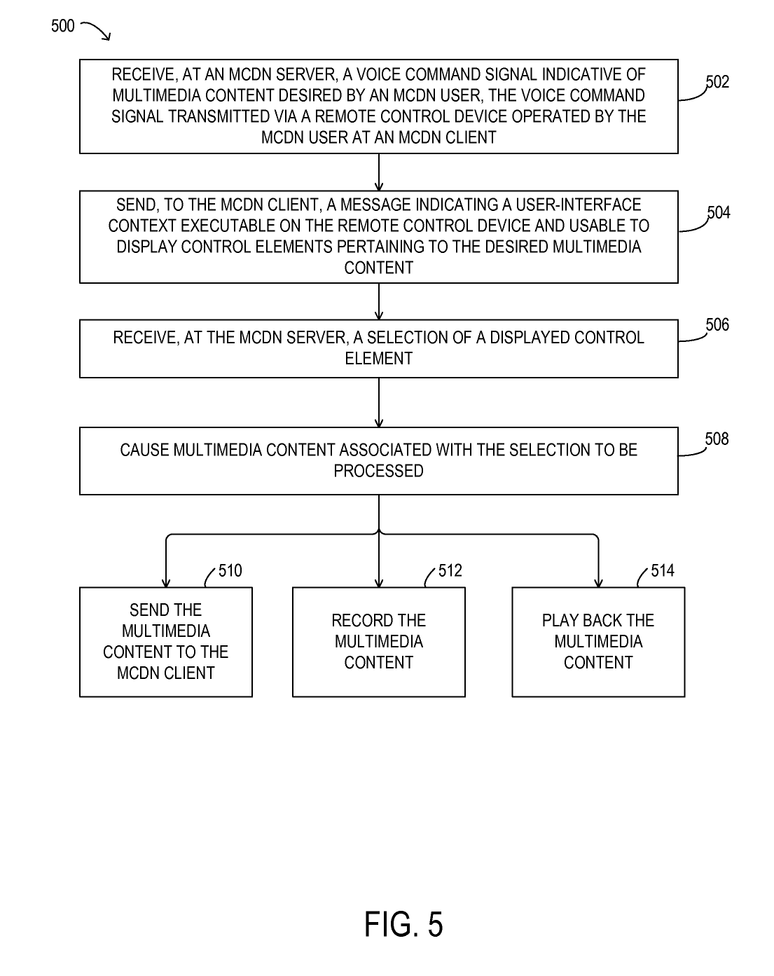

Turning now to FIG. 5, an embodiment of method 500 for network-integrated remote control is illustrated in flow chart form. In one embodiment, method 500 may be performed by remote control server 152 (see FIG. 1) in conjunction with local RC handler 326 (see FIG. 3). It is noted that certain operations described in method 500 may be optional or may be rearranged in different embodiments.

In method 500, a voice command signal, indicative of multimedia content desired by an MCDN user, may be received at an MCDN server, while the voice command signal may be transmitted via a remote control device operated by the MCDN user at an MCDN client (operation 502). The voice command signal may be received at the MCDN server as an audio signal or as a signal in a textual language format. In certain instances, the voice command signal may be received at the MCDN client as an audio signal or as a signal in a textual language format. One example of a textual language format is an American Standard Code for Information Interchange (ASCII) format. The voice command signal may represent a voice command uttered by an MCDN user at the remote control device. It is noted that the voice command may itself be indicative of at least one category of desired multimedia content, including: a geographic location, a topic of discussion, a dialog, an object, an event, a purchasable good, symbols, animals, colors, brand names, an actor, a character, a program genre, a name, a codeword, and a topic. For example, program genre may represent a type of program (i.e., a game show, a soap opera, a particular sporting match, etc.) and/or may indicate content in a program (i.e., comedy, travel, cooking, sports, etc.).

A message may be sent to the MCDN client that indicates a user interface context executable on the remote control device and usable to display control elements pertaining to the desired multimedia content (operation 504). The user interface context may be used by the remote control device to display a corresponding user interface, including control elements. In one embodiment, a search term describing the desired multimedia content may be determined in response to receiving the voice command signal in operation 502. The search term may be sent to an EPG search engine. A list of multimedia programs corresponding to the search term may be received from the EPG search engine. The list of multimedia programs may include multimedia programs categorized according to at least one of: genre, studio, duration, era, release year, sales revenue, language, media-type or format, performer, director, producer, investor, author, shooting location, trade association rating, content warnings, crew members, and award information. At least a portion of the received list of multimedia programs may be included in the user interface. The message may be a user interface message including the user interface context, which, in turn, may include the user interface or instructions executable to generate the user interface.

A selection of displayed control element may be received at the MCDN server (operation 506). The displayed control element may be selected by a user and sent to the MCDN server via the MCDN client. The control element may indicate multimedia content desired by the user. Multimedia content associated with the selection may then be caused to be processed (operation 508). After the selection is received, the multimedia content associated with the selection may be identified and/or located. Processing the multimedia content may include determining whether a user has obtained digital rights to receive the multimedia content, and if not, obtaining digital rights associated with the multimedia content. Processing the multimedia content in operation 508 may include sending the multimedia content to the MCDN client (operation 510). The MCDN client may then receive and output the multimedia content, for example, by displaying the multimedia content to a user. The multimedia content may be sent to the remote control device for output to a user. In certain embodiments, outputting the multimedia content may be performed after the multimedia content is received. Processing the multimedia content in operation 508 may include recording the multimedia content (operation 512). The recording may be performed by the MCDN server and/or the MCDN client. The user may be sent an indication that the recording has commenced and/or is completed. Processing the multimedia content in operation 508 may include playing back the multimedia content (operation 514). The multimedia content may be played back at the MCDN client and/or at the remote control device. The playback of the multimedia content may commence as soon as a portion of the multimedia content is sent. In this manner, method 500 provides voice-based remote control functionality within an MCDN environment, the functionality encompassing functionality for providing, to a remote control, user interface context that permits the remote control to generate a user interface based, at least in part, on a voice command.

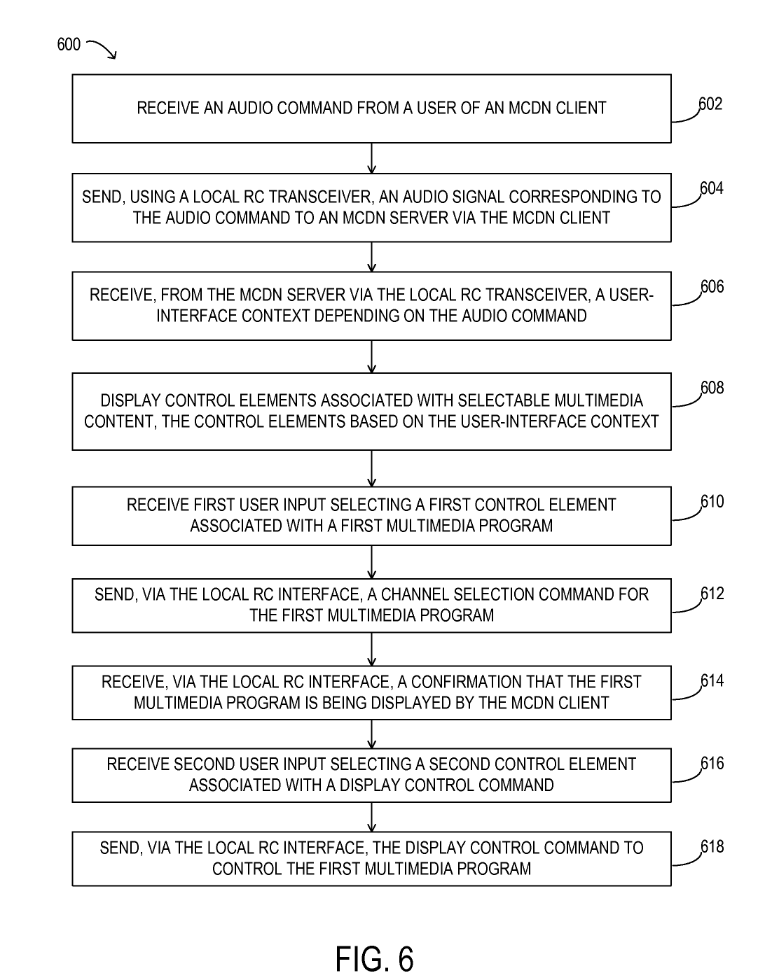

Referring now to FIG. 6, an embodiment of method 600 for network-integrated remote control is illustrated in flow chart form. In some embodiments, method 600 may be performed by remote control client 410 (see FIGS. 4 and 7) in conjunction with local RC handler 326 (see FIG. 3). In some embodiments, method 600 may be performed by remote control server 152 (see FIGS. 4 and 7) in conjunction with central RC handler 426. It is noted that certain operations described in method 600 may be optional or may be rearranged in different embodiments.

Method 600 may begin with receiving an audio command from a user of an MCDN client (operation 602). The audio command may be uttered by the user at the MCDN client. The audio command may be received by the remote control device, which is configured to operate at the MCDN client. Using a local RC transceiver, an audio signal corresponding to the audio command may be sent to an MCDN server via the MCDN client (operation 604). The audio signal may be a signal in a textual language format, such as an ASCII string. In some embodiments, the remote control device may be configured to convert a speech audio signal into the textual language format. Depending on the audio command, a user interface context may be received from the MCDN server via the local RC transceiver (operation 606). The user interface context may be sent by the MCDN server. Based on the user interface context, control elements associated with selectable multimedia content may be displayed (operation 608). The control elements may be displayed on a display device integrated in the remote control device. The display device may further include (or be coupled to) a tactile user input device, such as a touch screen. In this manner, the control elements may be viewable and selectable by the user. The content and form of the control elements may depend on the user interface context, which, in turn, may depend on the voice command. A user may thus control a user interface at the remote control device by issuing corresponding voice commands. The user may further control the user interface by selecting the control elements associated with a particular user interface context. In this regard, the voice commands may be considered as being ‘context specific.’

Method 600 may continue by receiving various types of user input at the remote control device. It is noted that while user input operations are described sequentially herein for clarity, various operations in method 600 may be performed concurrently or intermittently, as desired. First, user input selecting a first control element associated with a first multimedia program may be received (operation 610). The control element may be displayed in a user interface comprising a list of available multimedia programs that may be selected by the user. A channel selection command for the first multimedia program may be sent via the local RC interface (operation 612). The channel selection command may be routed to an MCDN server via the MCDN client, and may cause the first multimedia program to be sent to the MCDN client. A confirmation that the first multimedia program is being displayed by the MCDN client may be received via the local RC interface (operation 614). The remote control device may be configured to display the status of the MCDN client and/or the display of the first multimedia program. Second user input selecting a second control element associated with a display control command may be received (operation 616). A display control command may include functions for controlling a displayed multimedia program, for example, stop, play, pause, fast-forward, rewind, etc. The display control command may be received by the user viewing the first multimedia program and may be intended to control the first multimedia program. The display control command may be sent via the local RC interface (operation 618).

In certain embodiments, method 600 may include additional user input commands (not shown in FIG. 6). The user interface may be configured to enable the user to access an EPG. For example, third user input selecting a third control element for accessing the EPG may be received, and a corresponding EPG command sent via the local RC interface. The remote control device may also display instructions for navigating the user interface, which may depend on the displayed portion of the user interface. The navigating instructions may indicate audio commands and/or control elements accepted by the remote control device. In this manner, operation of the remote control device may be accomplished by a user in an autodidactic manner.

Thus, method 600 as depicted in FIG. 6, may represent an operational method performed by a set top box or other type of MHD in which a voice command is processed by the MHD, in conjunction with a network-based server, to generate and display user interface control elements, based at least in part on the voice command.

Referring now to FIG. 7, a block diagram illustrating selected elements of an embodiment of remote control device 700 is presented. In certain embodiments, remote control device 700 represents an example implementation of remote control 128 (see also FIGS. 2 and 3). Remote control device 700 may represent a hand-held device configured to provide remote control at MCDN client 120. The elements shown included in remote control device 700 may be physically implemented as a single, self-contained device. It is noted that remote control device 700 may include additional components, such as a power supply and a housing, which have been omitted from FIG. 7 for clarity. As shown in FIG. 7, remote control device 700 may operate in conjunction with MHD 125 (see also FIGS. 3 and 4) to execute the methods and operations described herein.

In the embodiment depicted in FIG. 7, remote control device 700 includes processor 702 coupled via shared bus 701 to storage media collectively identified as memory media 730. Remote control device 700, as depicted in FIG. 7, further includes local RC interface 704 that interfaces 322 to MHD 125 via local link 318, and through which remote control device 700 may communicate with other elements of MCDN 100 (see FIG. 1), as described previously herein. Also shown coupled to shared bus 701 are display 706, audio output 708, audio input 710, control elements 714, and touch sensor 712. As mentioned above, remote control device 700 may be configured to output multimedia content, including audio content, video content, images, text, or combinations thereof.

Display 706 may be implemented as a TV, a liquid crystal display screen, a computer monitor, or the like. Display 706 may comply with a display standard for computer monitors and/or television displays. Standards for computer monitors include analog standards such as VGA, XGA, etc., or digital standards such as DVI and HDMI, among others. A television display may comply with standards such as NTSC, PAL, or another suitable standard.

Audio output 708 may represent one or more speakers to play audio content and may, in certain instances, represent a set of speakers located at various locations. In this manner, audio output 708 may be configured to attain certain audio effects or a desired audio quality. Audio output 708 may also represent a connector for an external audio device, such as an audio jack for coupling headphones to. Similarly, audio input 710 may represent a microphone or audio transducer for capturing audio input provided by users of remote control device 700. Control elements 714 may represent physical or virtual controls, such as buttons, knobs, sliders, etc., that may be operated by users of remote control device 700. In particular embodiments, control elements 714 may include virtual control elements displayed by display 706 and operable using touch sensor 712, which may be a touch screen associated with display 706, or other tactile sensor. Accordingly, control elements 714 may represent static as well as dynamic controls that may be reconfigured for various input and output functions, as desired.

Memory media 730 encompasses persistent and volatile media, fixed and removable media, and magnetic and semiconductor media. Memory media 730 is operable to store instructions 731, data (not depicted), or both. Memory media 730 as shown may include sets or sequences of instructions 731-2, namely, an operating system 732, and remote control client 410 (see also FIG. 4), which may be configured to provide network-integrated remote control, as described herein. Operating system 732 may be a UNIX or UNIX-like operating system, a Windows® family operating system, or another suitable operating system. Instructions 731 may also reside, completely or at least partially, within processor 702 during execution thereof by remote control device 700.

Remote control client 410 may be configured to exchange instructions and data with remote control server 152 (see FIG. 1) via local RC handler 326 (see FIG. 3). Specifically, remote control client 410 may be configured to receive audio commands from users, provide a graphical interface for display to users, receive commands and selections from user, send remote control commands to local RC handler 326 for controlling MHD 125, and receive messages from remote control server 152 and/or local RC handler 326 (see FIGS. 1-4). The received messages may include a user interface context usable by remote control client 410 (see FIG. 4) to generate and display a user interface at remote control device 700. In this manner, remote control device 700 supports and displays user interfaces that are generated based on voice commands issued by a user. It is noted that remote control client 410 (see FIG. 4) may execute certain methods and operations described herein, such as portions of method 500 (see FIG. 5) and/or method 600 (see FIG. 6), or other operations.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for providing remote control via a multimedia content distribution network (MCDN), the method comprising:
receiving, at an MCDN server, a voice command signal indicative of a voice command from an MCDN client, wherein the voice command is indicative of desired multimedia content at the MCDN client;
sending, to the MCDN client, a user interface message indicating a user interface usable by the MCDN client to display control elements pertaining to the desired multimedia content;
receiving, at the MCDN server, an indication of a selection of a displayed control element; and
causing multimedia content associated with the selection to be processed, including at least one of:
sending the multimedia content to the MCDN client,
recording the multimedia content, and
playing back the multimedia content.

2. The method of claim 1, wherein the user interface is usable by the MCDN client to display the control elements on a remote control device display of a remote control device, and wherein the indication of the selection is received via the remote control device.

3. The method of claim 1, wherein the voice command signal is received at the MCDN server as an audio signal.

4. The method of claim 1, wherein the voice command signal is received at the MCDN server in a textual language format.

5. The method of claim 1, wherein the voice command is indicative of at least one category of multimedia content, including: a geographic location, a topic of discussion, a dialog, an object, an event, a purchasable good, symbols, animals, colors, brand names, an actor, a character, a program genre, a name, a codeword, and a topic.

6. The method of claim 1, further comprising:
in response to receiving the voice command signal, determining a search term describing the desired multimedia content; and
sending the search term to an electronic programming guide (EPG) search engine;
receiving, from the EPG search engine, a list of multimedia programs corresponding to the search term; and
including at least a portion of the list of multimedia programs in the user interface.

7. The method of claim 6, wherein the list of multimedia programs includes video-on-demand programs categorized according to at least one of: genre, studio, duration, era, release year, sales revenue, language, media-type or format, performer, director, producer, investor, author, shooting location, trade association rating, content warnings, crew members, and award information.

8. A multimedia handling device (MHD) for performing network-integrated remote control over a multimedia content distribution network (MCDN), the MHD comprising:
a processor coupled to memory media; and
a wireless transceiver;
wherein the memory media include processor instructions executable to:
receive a voice command signal from a remote control device at the wireless transceiver;
send the voice command signal to an MCDN server;
receive, from the MCDN server, a user interface context usable by the remote control device to display a user interface;
send the user interface context to the remote control device;
receive a selection command from the remote control device, wherein the selection command originates from a user interaction with the user interface; and
responsive to receiving the selection command, display multimedia content associated with the selection command.

9. The MHD of claim 8, wherein the user interface includes display elements, and wherein the selection command is associated with one of the display elements.

10. The MHD of claim 8, wherein the voice command signal is received at the MCDN server as an audio signal.

11. The MHD of claim 8, wherein the voice command signal is received at the MCDN server in a textual language format.

12. Computer-readable memory media, including instructions for network-integrated remote control of a multimedia content distribution network (MCDN) client, said instructions executable to:
receive an audio command from a user of the MCDN client;
send an audio signal corresponding to the audio command to a handler selected from a central RC handler of an MCDN server and local RC handler of a multimedia handling device;
receive, from the handler, a result depending on the audio command; and
process the result including displaying, when the result is a user interface context, a user interface on a display screen of a remote control device, the user interface being based on the user interface context and including control elements for controlling multimedia programs at the MCDN client;
wherein the instructions to send the audio signal comprise instructions to send the audio signal using at least one of: voice over Internet protocol and voice over wireless local area network.

13. The memory media of claim 12, further comprising instructions executable to:
receive first user input selecting a first control element associated with a first multimedia program; and
send to the MCDN server, via a local RC interface, a channel selection command for the first multimedia program.

14. The memory media of claim 13, further comprising instructions executable to:
receive, via the local RC interface, a confirmation that the MCDN client is outputting the first multimedia program;
receive second user input selecting a second control element associated with a display control command operable to control output of the first multimedia program; and
send, via the local RC interface, the display control command.

15. The memory media of claim 12, wherein the result is selected from a user interface context and a multimedia handling device instruction and wherein the user interface includes a list of multimedia programs associated with the audio command, and wherein the control elements are usable to select individual multimedia programs in the list of multimedia programs. the result selected from a user interface context and a multimedia handling device instruction.

16. The memory media of claim 12, further comprising instructions executable to:
display, based on the user interface, instructions for navigating the user interface.

17. The memory media of claim 16, wherein the navigating instructions indicate audio commands accepted by the remote control device.

18. The memory media of claim 16, wherein the navigating instructions indicate control elements displayed by the remote control device.

19. The memory media of claim 12, wherein the user interface is configured to enable the user to access an electronic programming guide (EPG) at the MCDN client.

20. The memory media of claim 19, further comprising instructions executable to:
receive third user input selecting a third control element for accessing the EPG.
